(19) United States
(12) Patent Application Publication
(10) Pub. No.: US 2012/0050409 A1
(43) Pub. Date: Mar. 1, 2012

(54) LIQUID DISCHARGING APPARATUS AND LIQUID DISCHARGING HEAD

(76) Inventors: Shunji Yamaguchi, Kanagawa (JP); Hitoshi Kamoda, Kanagawa (JP); Shigeyoshi Hirashima, Kanagawa (JP)

(21) Appl. No.: 13/211,837

(22) Filed: Aug. 17, 2011

(30) Foreign Application Priority Data
Aug. 25, 2010 (JP) P2010-188556

(51) Int. Cl. B41J 2/16

(52) U.S. Cl. 347/47

(57) ABSTRACT

A liquid discharging apparatus includes a liquid discharging head that has a nozzle surface formed with nozzles discharging liquid, and a surrounding portion that is protruded from the nozzle surface and surrounds the nozzles; and a support member that is moved between a contact position coming into contact with the surrounding portion and a separation position separated from the surrounding portion, when being situated in the separation position, the support member supporting a medium on which liquid discharged from the nozzles is landed, and when being situated in the contact position, the support member sealing the nozzles.

### BACKGROUND

The present disclosure relates to a liquid discharging apparatus and a liquid discharging head.

As a liquid discharging apparatus, for example, an ink jet printer is generally used which discharges ink as liquid to a medium to print an image. Such a liquid discharging apparatus includes a liquid discharging head that has a nozzle surface formed with nozzles which discharge liquid to the medium, and a support member that supports the medium facing the nozzle surface. Moreover, during printing, an image is printed by discharging liquid from the nozzles to the medium supported by the support member.

Incidentally, during standby when liquid is not discharged to the medium, in order to protect the nozzles from garbage, dust, drying or the like, the liquid discharging apparatus seals the nozzles by cap members made of rubber or the like (see, Japanese Unexamined Patent Application Publication No. 2009-190233). In addition, in order to seal the nozzles using the cap members, there is a necessity to form a space where the cap members can be situated between the liquid discharging head and the support member, and the cap members or the support member is moved.

### SUMMARY

However, when the movement mechanisms of the cap members and the support member for sealing the nozzles are provided, the configuration of the apparatus is complicated. Furthermore, in the case of the complicated configuration, there is a problem in that, since there is a necessity to secure the movement time of each member, the time from the printing to the sealing of the nozzles is lengthened, whereby the nozzle surface is not suitably protected.

Thus, it is desirable to provide a newly improved liquid discharging apparatus and a liquid discharging head that are capable of rapidly sealing the nozzles using a simple configuration.

According to an embodiment of the present disclosure, there is provided a liquid discharging apparatus that includes a liquid discharging head that has a nozzle surface formed with nozzles discharging liquid, and a surrounding portion that is protruded from the nozzle surface and surrounds the nozzles; and a support member that is moved between a contact position coming into contact with the surrounding portion and a separation position separated from the surrounding portion, when being situated in the separation position, the support member supporting a medium on which liquid discharged from the nozzles is landed, and when being situated in the contact position, the support member sealing the nozzles.

Furthermore, the liquid discharging head may have a spur that is provided further on the upstream side in the transport direction of the medium than the surrounding portion, protruded from the surrounding portion toward the support member, and is capable of coming into contact with the medium.

Furthermore, the spur may be supported on the liquid discharging head by a spring shaft.

Furthermore, the support member may have a concave portion that accommodates the spur when being situated in the contact position.

Furthermore, the surrounding portion may have a protrusion portion that comes into contact with the support member when the support member is situated in the contact position, and the support member may seal the nozzles by coming into contact with the protrusion portion.

Furthermore, the liquid discharging head may be fixedly supported so as not to be movable to an apparatus main body.

Furthermore, according to another embodiment of the present disclosure, there is provided a liquid discharging head that includes a nozzle surface formed with nozzles which discharge liquid to a medium supported by opposed support members, and a surrounding portion that is protruded from the nozzle surface and surrounds the nozzles, when coming into contact with the support members, the surrounding portion sealing the nozzles.

According to the embodiment of the present disclosure described above, it is possible to provide a liquid discharging apparatus that has a simple configuration and is capable of rapidly sealing the nozzles.

### BRIEF DESCRIPTION OF THE DRAWINGS

FIG. 1 is a block diagram that shows the overall configuration of a printer;

FIG. 2 is a perspective view that shows an inner configuration of a printer;

FIG. 3 is a cross-sectional view that shows an inner configuration of a printer;

FIG. 4 is a perspective view in which a head unit is viewed from a bottom surface side;

FIG. 5 is a perspective view that shows a spur;

FIG. 6 is a perspective view that shows a maintenance unit 40;

FIG. 7 is a cross-sectional view in which a contact state of a rib to a platen is viewed from a side;

FIG. 8 is a cross-sectional view in which a contact state of a rib to a platen is viewed from a front;

FIG. 9 is an enlarged view of a region A of FIG. 7;

FIG. 10 is a cross-sectional view in which a separation state of a rib from a platen is viewed from a side;

FIG. 11 is an enlarged view of a region B of FIG. 10;

FIG. 12 is an enlarged view of a region C of FIG. 10;

FIG. 13A is a diagram that shows a state in which nozzles are sealed;

FIG. 13B is a diagram that shows a state in which a maintenance unit descends;

FIG. 13C is a diagram that shows a state in which a mover is moved to a lower portion of a head unit;

FIG. 13D is a diagram that shows a starting state of the cleaning of a nozzle surface;

FIG. 13E is a diagram that shows an ending state of the cleaning of a nozzle surface;

FIG. 14A is a diagram that shows a standby state in which a cap member comes into contact with a nozzle surface;

FIG. 14B is a diagram that shows a movement state of a transport portion and a cap unit; and

FIG. 14C is a diagram that shows a printing state in which a cap member is retreated.

### DETAILED DESCRIPTION OF EMBODIMENTS

Hereinafter, preferred embodiments of the present disclosure will be described in detail. In addition, in the present specification and the drawings, components having substantially the same function will be denoted by the same reference numerals and the repeated descriptions thereof will be omitted.

In addition, the present description will be made in the following order:
1. Overview of Liquid Discharging Apparatus
2. Configuration of Head Unit
3. Configuration of Maintenance Unit
   3-1. Detailed Configuration of Platen Unit
   3-2. Detailed Configuration of Cleaning Unit
4. Operation Example of Platen Unit
5. Operation Example of Cleaning Unit
6. Effectiveness of Printer According to the Present Embodiment
7. Other Embodiments

### 1. Overview of Liquid Discharging Apparatus

In the present embodiment, a color ink jet printer (hereinafter, a printer 10) as an example of a liquid discharging apparatus will be described. The printer 10 of the present embodiment is a printing apparatus that prints an image on a paper S by discharging four color inks of, for example, Y (yellow), M (magenta), C (Cyan), and K (black) onto the paper S that is an example of a medium.

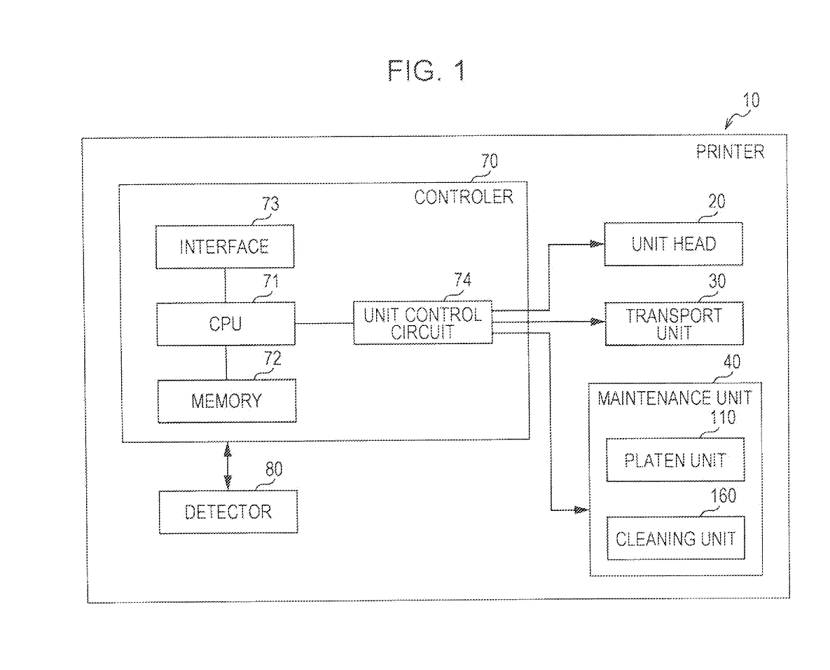

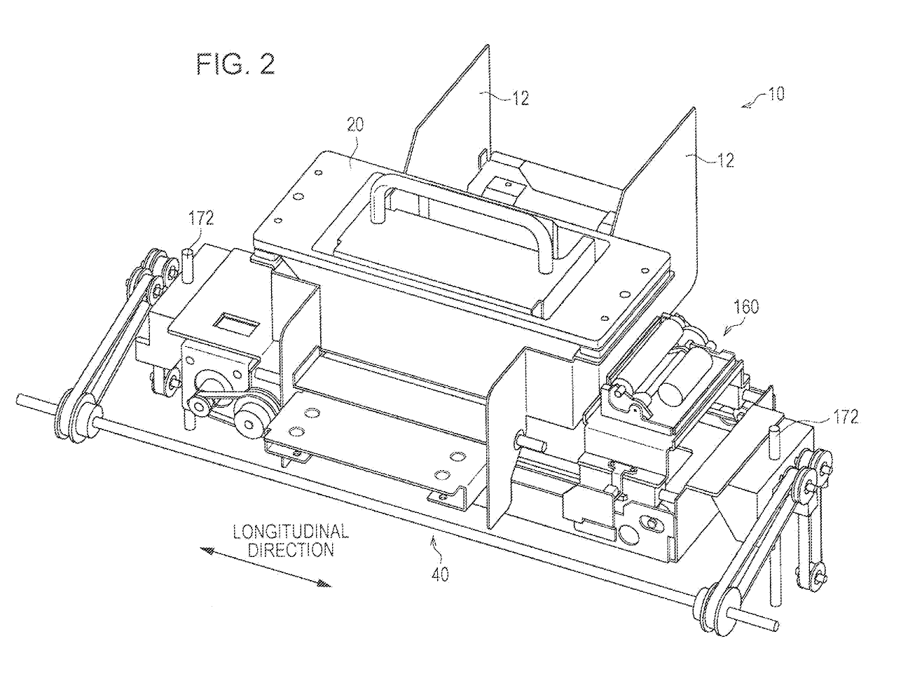

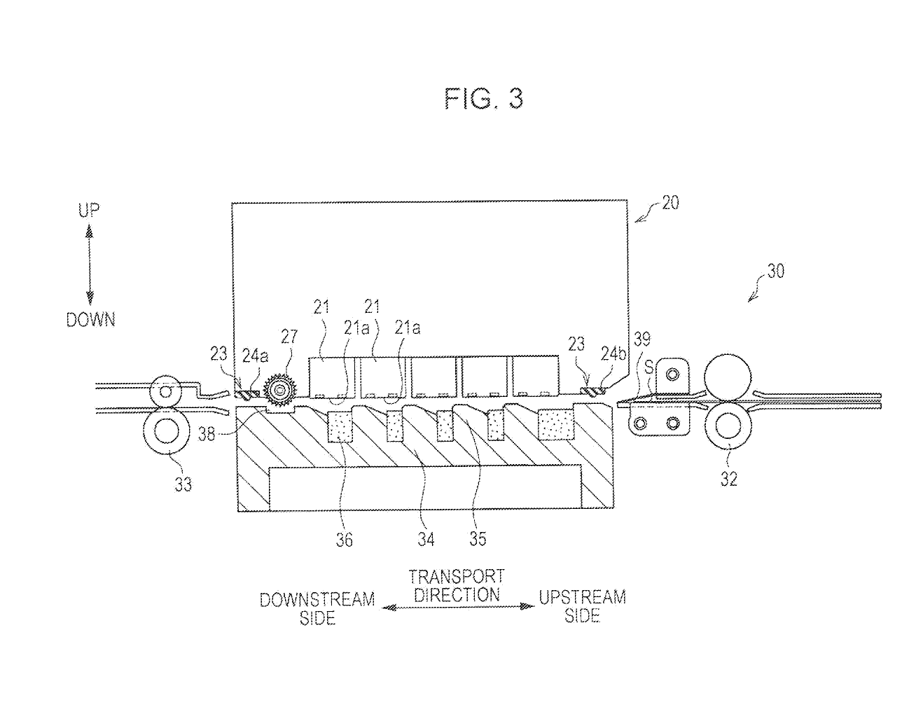

Hereinafter, a configuration example of the printer 10 will be described with reference to FIGS. 1 to 3. FIG. 1 is a block diagram that shows the overall configuration of the printer 10. FIG. 2 is a perspective view that shows an inner configuration of the printer 10. FIG. 3 is a cross-sectional view that shows an inner configuration of the printer 10.

As shown in FIG. 1, the printer 10 has a head unit 20, a transport unit 30, a maintenance unit 40, a controller 70, and a detector 80.

The head unit 20 discharges ink to the paper S so as to print the image on the paper S. As shown in FIG. 2, the head unit 20 is fixed to a pair of main body frames 12 by a screw or the like. That is, while the printer 10 is operated, the head unit 20 is not moved.

Furthermore, as shown in FIG. 3, the head unit 20 has a plurality of line heads 21 provided for each color of ink. The respective line heads 21 are elongated liquid discharging heads having widths longer than that of a paper width of the paper S, and have a nozzle surface 21a formed with nozzles Nz in the lower portion thereof. In each nozzle Nz, an energy generation element (specifically, heating resistor) (not shown) and an ink liquid chamber are provided. Moreover, air bubbles are generated in the ink liquid chamber along with the driving of the heating resistor, and the ink is discharged from each nozzle Nz by energy when the air bubbles are generated.

Moreover, when a region (a printing region where an image is printed) on the paper S passes through immediately below the line head 21, each line head 21 discharges ink from the nozzles Nz. That is, each line head 21 discharges the ink when the nozzle surface 21a faces the paper S. As a result, in the printing region on the paper S, as many dots as the width of the paper are formed at one time.

The transport unit 30 transports the paper S in the transport direction so that the printing region on the paper S passes through immediately below the respective line heads 21. As shown in FIG. 3, the transport unit 30 has an upstream side transport roller 32, a downstream side transport roller 33, and a platen 34 that is an example of a support member.

The upstream side transport roller 32 is a pair of rollers that is situated on the upstream side of the head unit 20 in a transport direction. The downstream side transport roller 33 is a pair of rollers that is situated on the downstream side of the head unit 20 in the transport direction. The upstream side transport roller 32 and the downstream side transport roller 33 are transported in the transport direction in the state of interposing the paper S therebetween.

The platen 34 is a table that is situated between the upstream side transport roller 32 and the downstream side transport roller 33 in the transport direction and supports the paper S to be transported. In the present embodiment, the platen 34 constitutes a part of the platen unit 110. In addition, the detailed configuration of the platen unit 110 will be described later.

The maintenance unit 40 performs the maintenance so that the ink discharging from the nozzles Nz is satisfactorily maintained in regard to the respective line heads 21 that are in the resting state (a state of not discharging ink to the paper S). In addition, the detailed configuration of the maintenance unit 40 will be described later.

The controller 70 controls each unit (the head unit 20, the transport unit 30, and the maintenance unit 40). Specifically, the controller 70 controls each unit of the printer 10 by a CPU 71 via a unit control circuit 74 according to a program stored in a memory 72. Furthermore, the controller 70 is able to communicate with a computer (not shown) via an interface 73. Moreover, when receiving printing data from the computer, the controller 70 controls each unit based on the printing data to print the image depending on the printing data on the paper S.

The detector 80 detects the situation in the printer 10. For example, the detector 80 has a paper detection sensor that detects the position of the paper S on the transport path. The detector 80 outputs the signal depending on the detection result toward the controller 70. The controller 70 receives the signal and controls each unit.

Next, the printing processing will be described which prints the color image on the paper S using the printer 10 having the configuration described above. The printing processing is started from that the controller 70 receives the printing data from the computer via the interface 73. The controller 70 interprets the contents of various commands in the received printing data to control each unit of the printer 10. As a result, the transport operation by the transport unit 30 is executed first. That is, the paper S is transported in the transport direction, by the upstream side transport roller 32 or the downstream side transport roller 33.

The controller 70 executes the ink discharging operation by the head unit 20 while executing the transport operation by the transport unit 30. That is, each line head 21 discharges the ink to the printing region on the paper S situated in the opposed position (supported by the platen 34). As a result, as many dots as the paper width of the paper S are formed at one time. As a consequence, the color image is printed on the paper S.

### 2. Detailed Configuration of Head Unit 20

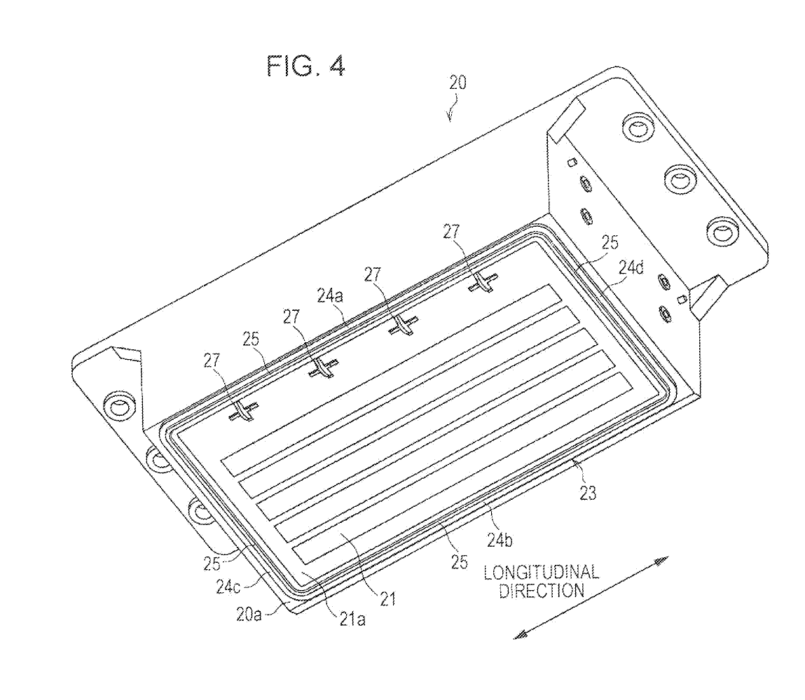

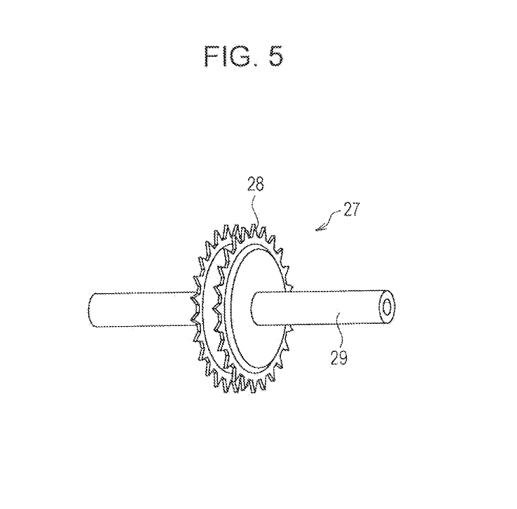

Next, the detailed configuration of the head unit 20 will be described based on FIGS. 4 and 5. FIG. 4 is a perspective view in which the head unit 20 is viewed from the lower surface 20a side. FIG. 5 is a perspective view that shows a spur 27.

As shown in FIG. 4, the head unit 20 has a nozzle surface 21a formed with the nozzles Nz mentioned at the lower surface 20a thereof. Furthermore, the head unit 20 has a rib 23 as an example of a surrounding portion, and a spur 27 in the lower surface 20a side.

The rib 23 seals the nozzles of the line heads 21 in cooperation with the platen 34. The rib 23 is protruded from the lower surface 20a toward the platen 34. Furthermore, the rib 23 surrounds the nozzles Nz of the line heads 21. Moreover, as shown in FIG. 4, the rib 23 has a base portion 24 and a protrusion 25.

The base 24 is fixed to the lower surface 20a of the head unit 20 by an adhesive or the like. The plane shape of the base portion 24 has a rectangular shape with a hole formed in a center side. That is, the base portion 24 includes four sides and has base portions 24a, 24b, 24c and 24d. The base portions 24a to 24d are situated in edges of the lower surface 20a, respectively. For this reason, the size of the base portion 24 has substantially the same size as that of the lower surface 20a of the head unit 20.

The protrusion 25 is a protrusion portion that is protrudes from the base portion 24 toward the platen 34 side. The protrusion 25 has a rectangular shape in the same manner as the base portion 24. That is, the protrusion 25 is also provided so as to surround the nozzles Nz. Moreover, the protrusion 25 of the rib 23 comes into contact with the platen 34 during capping operation described later, thereby sealing the nozzles Nz of the line head 21.

The spur 27 presses the paper S against the platen 34 side. In the present embodiment, four spurs 27 are provided along a longitudinal direction of the head unit 20 at equal intervals. Furthermore, four spurs 27 are situated inside the rib 23. Specifically, as shown in FIG. 3, the spurs 27 are situated between the line head 21 and the base portion 24a in the transport direction. Moreover, as shown in FIG. 5, the spur 27 has teeth portions 28 and a spring shaft 29.

The teeth portions 28 are thin metallic teeth coming into contact with the paper S during transportation. As shown in FIG. 3, the teeth portions 28 are situated further to the platen 34 side than the protrusion 25 of the rib 23 in a vertical direction. Furthermore, the teeth portions 28 are rotated as the contacting paper S are further transported. That is, the teeth portions 28 apply force that presses the paper S to the lower portion of the vertical direction, but does not interfere with the progress of the paper S in the transport direction. For this reason, the paper S during transportation is transported to a position separated from the rib 23 in the vertical direction when passing through the teeth portions 28.

The spring shaft 29 is rotatably supported by the head unit 20. The spring shaft 29 is able to be rotated integrally with the teeth portions 28. Moreover, the spring shaft 29 has spring property, and assists the function of the teeth portions 28 (a function of pressing the paper S to the lower portion of the vertical direction) that acts on the paper S.

By providing the spur 27 having the configuration mentioned above, it is possible to prevent the paper S from coming into contact with the rib 23 (specifically, the base portion 24a). That is, the paper S passing through the line head 21 is further transported while coming into contact with the spur 27 protruded from the rib 23, whereby the paper S can be prevented from coming into contact with the rib 23. Thus, it is possible to prevent an occurrence of a jam or the like, for example, due to the contact of the paper S to the rib 23.

In addition, the spur 27 prevents that the paper S comes into contact with the base portion 24a in the transport direction. However, in order to prevent the paper S from coming into contact with the base portion 24b, the transport unit 30 has a paper presser 39 shown in FIG. 3 on the upstream side in the transport direction from the base portion 24b. The paper presser 39 is situated between the upstream side transport roller 32 and the head unit 20 in the transport direction, and guides the papers S toward the platen 34 side. The paper presser 39 is formed of a sheet material or the like. Of course, instead of the paper presser 39, the head unit 20 may have the spur on the upstream side in the transport direction from the base portion 24b.

### 3. Configuration of Maintenance Unit 40

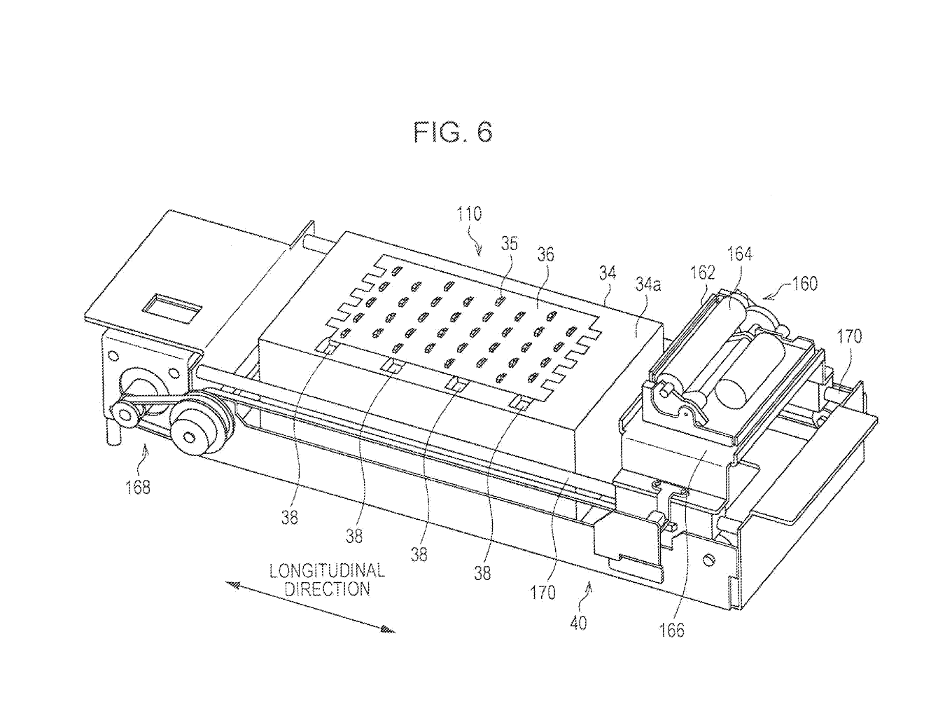

As mentioned above, the maintenance unit performs the maintenance so that the ink discharging from the nozzles Nz is satisfactorily maintained to the respective line heads 21 that is in the resting state (a state of not discharging the ink). The configuration of the maintenance unit 40 will be described using FIG. 6. FIG. 6 is a perspective view that shows the maintenance unit 40.

The maintenance unit 40 has a platen unit 110, and a cleaning unit 160. The platen unit 110 seals the nozzles Nz in cooperation with the rib 23 of the head unit 20. The cleaning unit 160 cleans the nozzle surface 21a. In the following, the detailed configuration of the platen unit 110, and the detailed configuration of the cleaning unit 160 will be sequentially described.

### 3-1. Detailed Configuration of Platen Unit 110

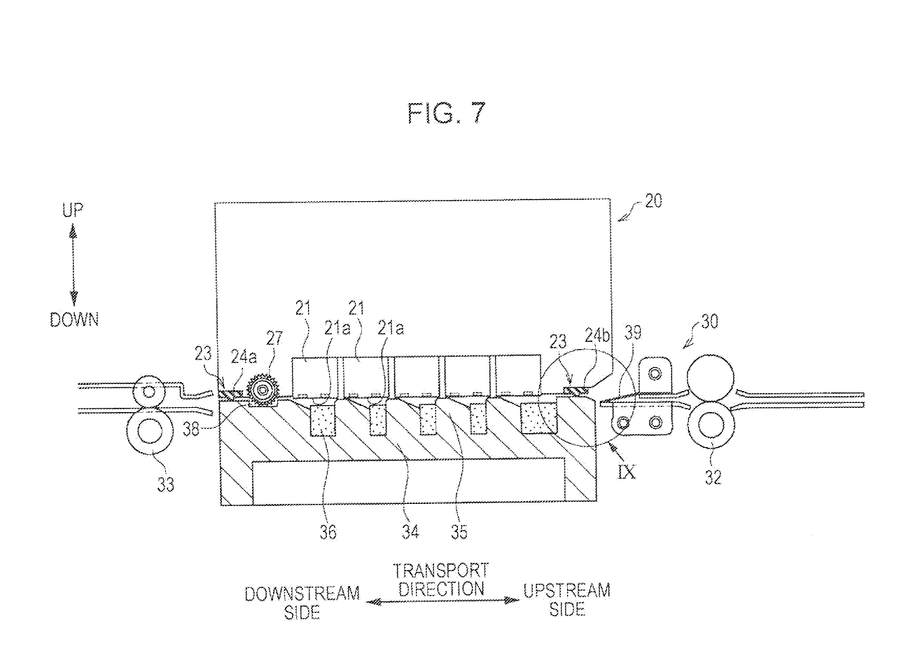

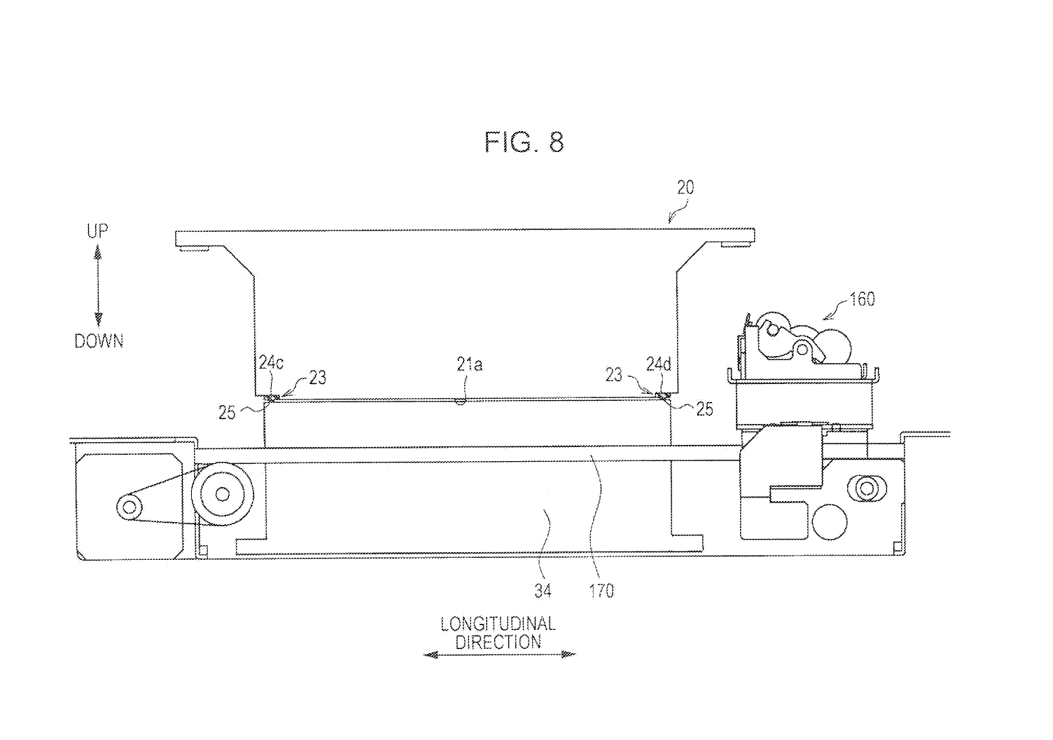

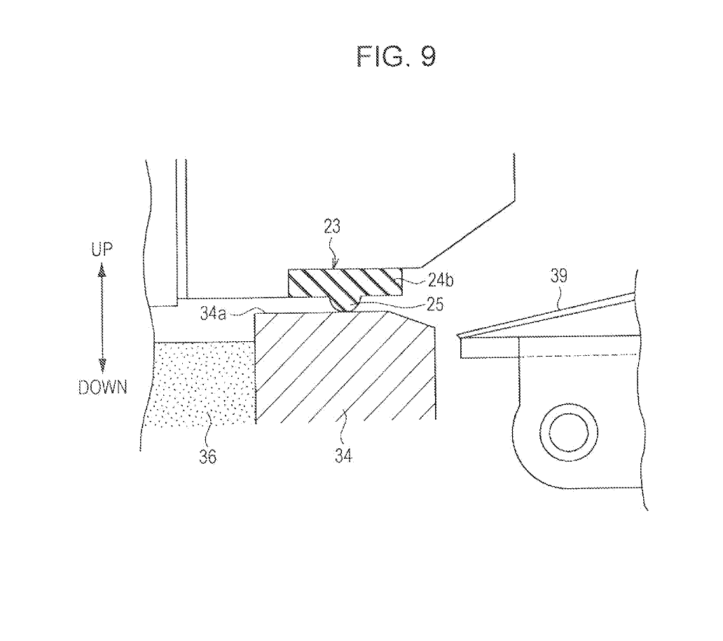

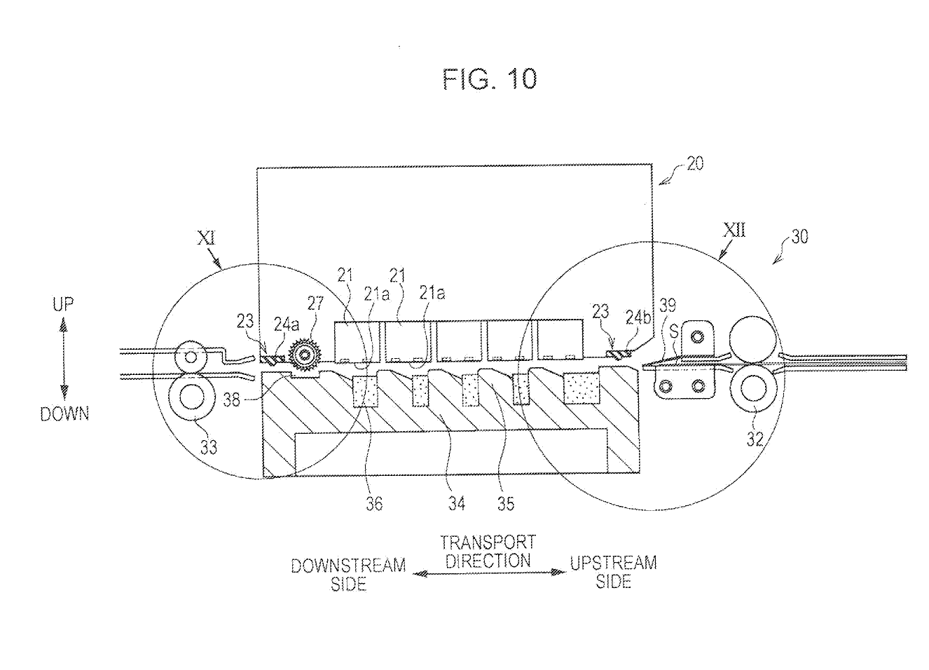

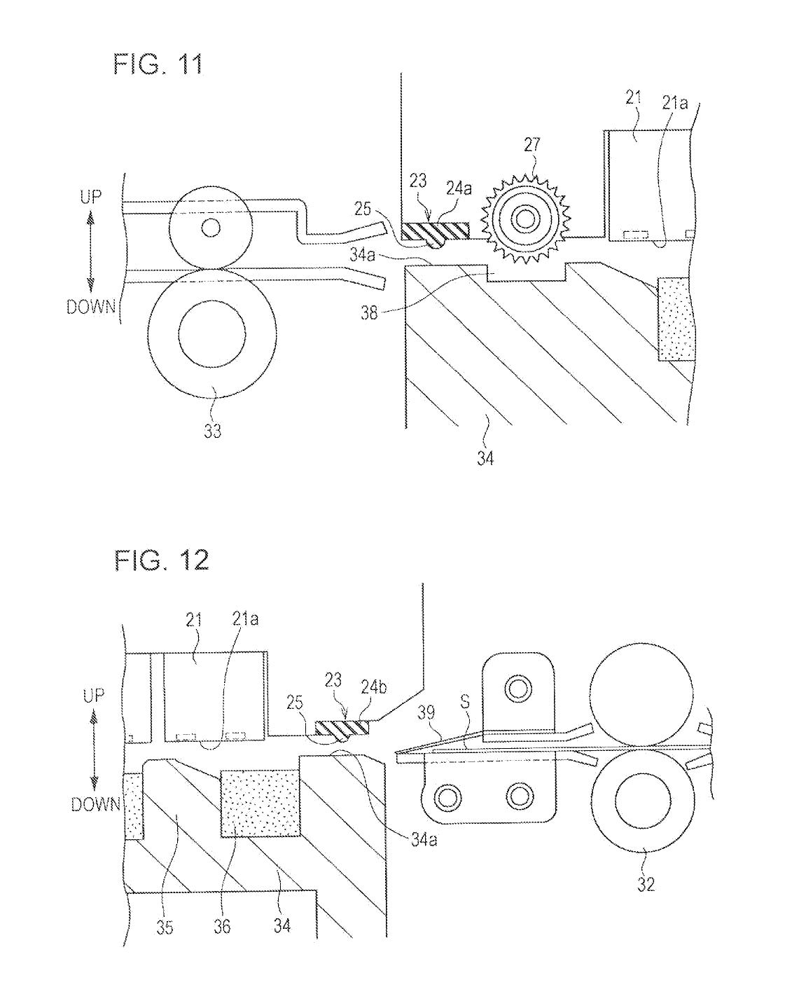

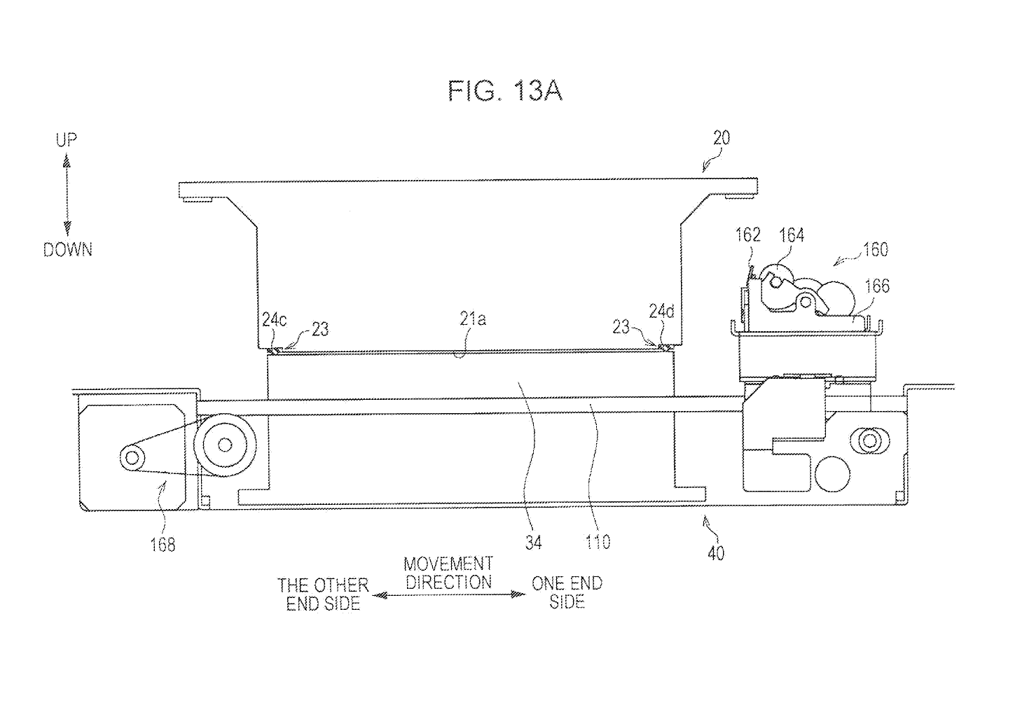

Firstly, the detailed configuration of the platen unit 110 will be described using FIGS. 6 to 12. FIG. 7 is a cross-sectional view in which the abutting state of the rib 23 to the platen 34 is viewed from the side. FIG. 8 is a cross-sectional view in which the abutting state of the rib 23 to the platen 34 is viewed from the front. FIG. 9 is an enlarged view of a region A of FIG. 7. FIG. 10 is a cross-sectional view in which the separation state of the rib 23 from the platen 34 from the side. FIG. 11 is an enlarged view of a region B of FIG. 10. FIG. 12 is an enlarged view of a region C of FIG. 10.

The platen unit 110 has the platen 34, and a driving portion (not shown) that moves the platen 24 in the vertical direction. The platen 34 according to the present embodiment has a function of supporting the paper S during transportation, and a function of sealing the nozzles Nz of the line head 21.

The platen 34 is situated between the upstream side transport roller 32 and the downstream side transport roller 33 in the transport direction, and faces the nozzle surface 21a of the line head 21. As shown in FIG. 6, a rib 35 and an ink absorbent material 36 are provided in the platen 34. The rib 35 supports the paper S on which the ink discharged from the nozzles is landed. A plurality of ribs 35 is formed in the position facing the nozzle surface 21a. Specifically, as shown in FIG. 6, a plurality of ribs 35 is provided so as to be arranged at predetermined intervals.

The ink absorbent material 36 absorbs the ink discharged from the nozzles toward the platen 34. For example, the ink absorbent material 36 absorbs the ink discharged from the nozzles Nz as the preliminary discharging before the printing is started.

Incidentally, the platen 34 according to the present embodiment has a configuration that is capable of being moved in the vertical direction by the driving portion. Specifically, the platen 34 is moved between the abutting position (see FIGS. 7 and 8) abutting the rib 23 of the head unit 20 and the separation position (see FIG. 10) separated from the rib 23. Moreover, the platen 34 supports the paper S on which the ink discharged from the nozzles Nz of the line head 21 is landed, upon being situated in the separation position. Meanwhile, the platen 34 seals the nozzles Nz in cooperation with the rib 23 upon being situated in the abutting position (contact position).

Furthermore, upon being situated in the abutting position, the platen 34 abuts against the protrusion 25 of the rib 23. Specifically, an abutting surface 34a around the rib 35 of the platen 34 abuts against the protrusion 25. Moreover, the abutting surface 34a abuts against the protrusion 25, whereby the nozzles Nz are sealed. For this reason, even if the abutting pressure is small, the nozzles Nz can be effectively sealed.

In this manner, the platen 34 according to the present embodiment can rapidly perform the transition between the printing state and the sealing state of the nozzles simply by being moved between the abutting position and the separation position by the slight movement. For this reason, it is possible to greatly suppress the time when the nozzles come into contact with air without discharging the ink onto the paper S, whereby the clogging in the nozzles Nz can be effectively prevented.

On the downstream side in the transport direction from the rib 35 of the platen 34, a concave portion 38 is provided. The concave portion 38 is a depression that is formed in the position facing the spur 27 of the head unit 20 on an upper surface (a surface facing the nozzle surface 21a) of the platen 34. In the present embodiment, as shown in FIG. 6, four concave portions 38 are formed along the longitudinal direction at equal intervals. Moreover, when the platen 34 is situated in the abutting position, the concave portion 38 accommodates the spur 27. As a result, it is possible to prevent the spur 27 from coming into contact with the platen 34.

By the platen unit 110 of the configuration mentioned above, it is possible to suppress the solvent evaporation of ink in the vicinity of the opening of the nozzle Nz of the line head 21 when the line head 21 is in the resting state, which prevents an occurrence of the clogging in the nozzle Nz.

In addition, a suction pump (not shown) is connected to the platen unit 120. The suction pump is operated, for example, in the state in which the platen 34 seals the nozzles Nz. As a result, the spaces in the platen 34 and the nozzle surface 21a enter a negative pressure state, whereby the ink in the nozzles Nz are absorbed and forcibly discharged. The line head 21 performing the suction operation can maintain the state of satisfactorily emitting the ink from the nozzles Nz.

### 3-2. Detailed Configuration of Cleaning Unit 160

Next, the detailed configuration of the cleaning unit 160 will be described using FIG. 6 mentioned above.

The cleaning unit 160 cleans the nozzle surface 21a of the line head 21. As shown in FIG. 6, the cleaning unit 160 has a blade 162, a wiper 164, a mover 166, and a driving portion 168.

The blade 162 scrapes the dust or the thickening ink attached to the nozzle surface 21a. The blade 162 is, for example, a rubber blade formed of a rubber material, and comes into contact with the nozzle surface 21a to scrape the dust or the like.

The wiper 164 wipes out the dust or the thickening ink attached to the nozzle surface 21a. The wiper 164 is, for example, a sponge-like porous roller, and comes into contact with the nozzle surface 21a to wipe out the dust or the like.

The mover 166 is moved in the movement direction in the state of holding the blade 162 and the wiper 164. The mover 166 is moved in the movement direction along a pair of shaft guides 170. Moreover, the mover 166 is moved in the movement direction in the state in which the blade 162 and the wiper 164 come into contact with the nozzle surface 21a, whereby the nozzle surface 21a is cleaned.

The driving portion 168 moves the mover 166 in the movement direction. The driving portion 168 has a motor as a driving source, a gear or the like.

When the nozzle surface 21a is cleaned by the cleaning unit 160, the maintenance unit 40 descends along the shaft 172 in the vertical direction due to a driving source (not shown) provided in the maintenance unit 40. As a result, a gap is formed between the line head 21 and the platen 34 in the vertical direction. When the mover 166 is moved in the formed space, the nozzle surface 21a is cleaned by the blade 162 and the wiper 164. In addition, the cleaning operation of the nozzle surface 21a by the cleaning unit 160 will be described later.

Although the cleaning unit 160 has the blade 162 and the wiper 166 in the embodiment mentioned above, the present disclosure is not limited thereto. For example, the cleaning unit 160 may have any one of the blade 162 and the wiper 166.

### 4. Operation Example of Platen Unit 110

An operation example of the platen unit 110 upon sealing the nozzles Nz will be described using FIGS. 7 and 10 mentioned above.

The sealing operation of the nozzles by the platen unit 10 is executed by the controller 70. Moreover, in the present embodiment, the sealing of the nozzles Nz by the platen 34 is consecutively executed when the printer 10 is in the resting state (state in which the ink is not discharged onto the paper S). The reason is that, when the nozzles are intermittently sealed, there is concern of the nozzles drying or the like while the nozzles are not sealed.

Firstly, an operation example of the platen unit 110 upon sealing the nozzles Nz immediately after the image printing onto the paper S will be described.

When the image is printed on the paper S, as shown in FIG. 10, the platen 34 is situated in the separation position. Moreover, the platen 34 supports the paper S in which the ink discharged from the nozzles is landed.

Moreover, when the paper S is situated to the downstream side from the line head 21 in the transport direction, the platen unit 110 starts the operation and seals the nozzles Nz. That is, the platen 34 situated in the separation position rises in the vertical direction due to a driving portion (not shown). Moreover, when the moved platen 34 is situated in the abutting position, as shown in FIG. 7, the abutting surface 34a abuts against the protrusion 25 of the rib 23. As a result, the nozzles Nz are sealed. In addition, when the platen 34 is situated in the abutting position, the spur 27 is accommodated in the concave portion 38.

In addition, when the platen unit 110 is operated, the head unit 21 is not moved. That is, the nozzles Nz are sealed only by the movement of the platen 34 facing the line head 21. For this reason, immediately after the image is printed on the paper S, the nozzles Nz are sealed.

Next, an operation example of the platen unit 110 upon discharging the ink onto the paper S from the sealing state of the nozzles Nz will be described.

In order to discharge the ink onto the paper S from the sealing state of the nozzles Nz, there is a necessity to move the platen 34 situated in the abutting position shown in FIG. 7 to the separation position. Moreover, in the present embodiment, the timing of moving the platen 34 to the separation position is immediately before the paper S faces the line head 21. For example, when the upstream side transport roller 22 starts to transport the paper S, the platen 34 is moved to the separation position.

The movement of the platen 34 to the separation position is also executed by the driving of a driving portion (not shown). That is, the platen 34 situated in the abutting position descends in the vertical direction and is situated in the separation position. Immediately after the platen 34 is situated in the separation position, ink is discharged to the paper S transported onto the platen 34. In addition, the paper S is transported while coming into contact with the paper presser 39 and the spur 27, whereby it is possible to prevent the paper S from coming into contact with the rib 23.

In this manner, since the nozzles Nz are sealed immediately before discharging the ink to the paper S, the drying of the nozzles Nz can be effectively prevented. In addition, the detector 80 (FIG. 1) detects the position of the paper S on the transport path, whereby the movement of the platen 34 is controlled based on the position of the detected paper S.

Incidentally, in the present embodiment, in the present embodiment, when the nozzles Nz are sealed or unsealed by the platen unit 110, the head unit 20 is not moved. For this reason, since the sealing and the unsealing are rapidly performed, it is possible to effectively prevent the nozzles Nz from the dust or the drying. Furthermore, since the head unit 20 is not moved in the vertical direction but is fixed, the meniscus of the nozzles Nz can be uniformly maintained.

### 5. Operation Example of Cleaning Unit 160

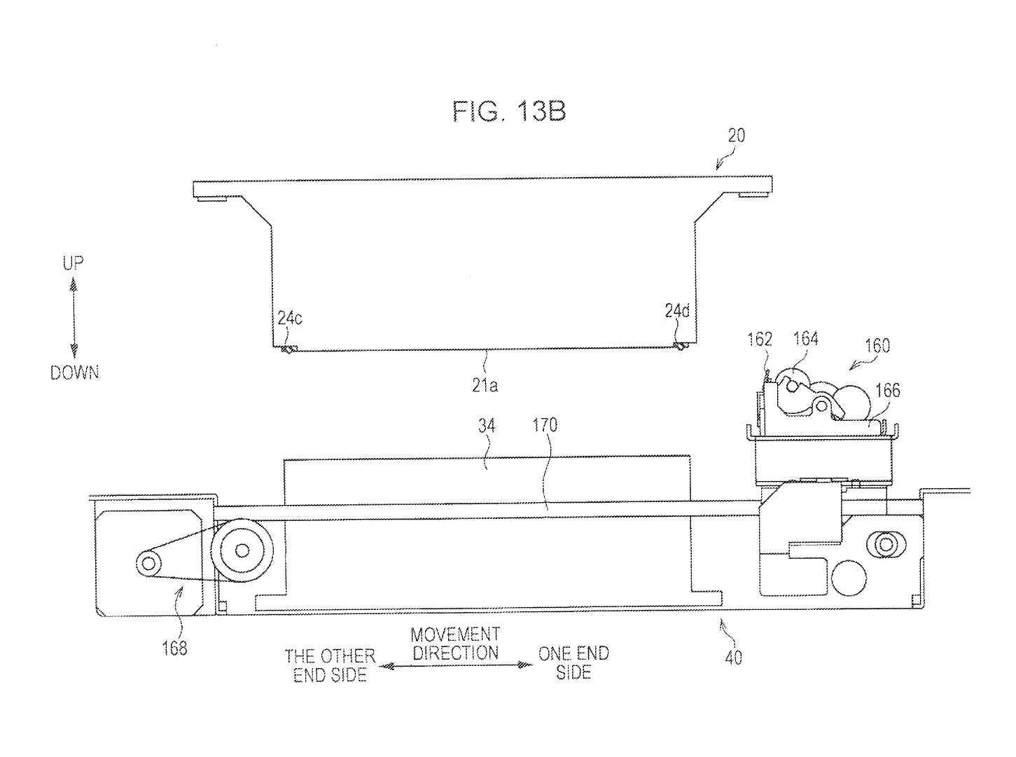

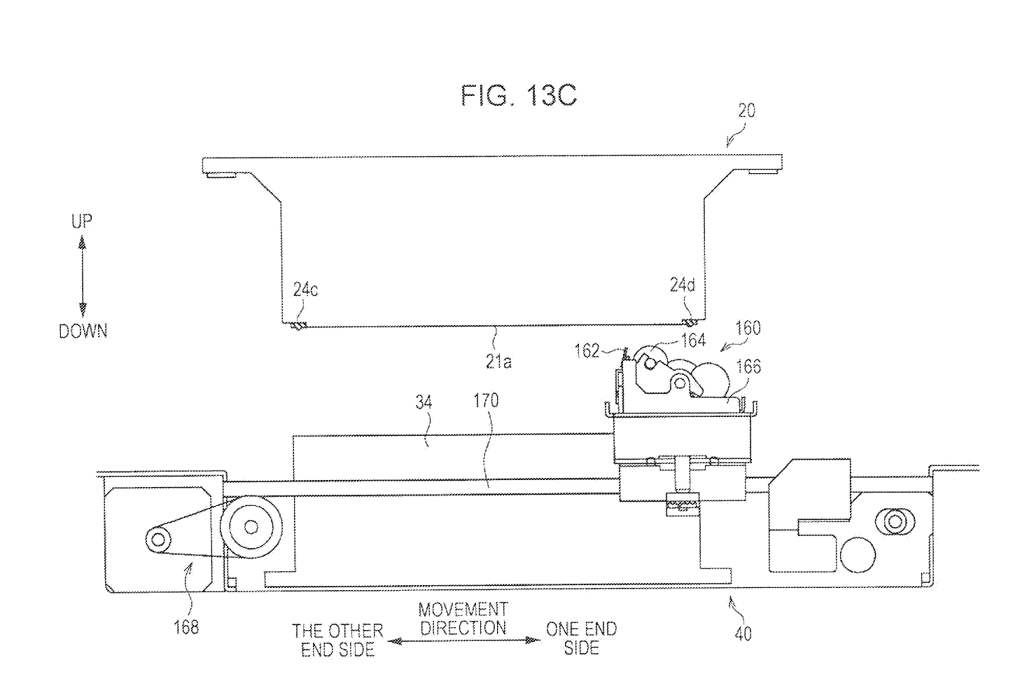

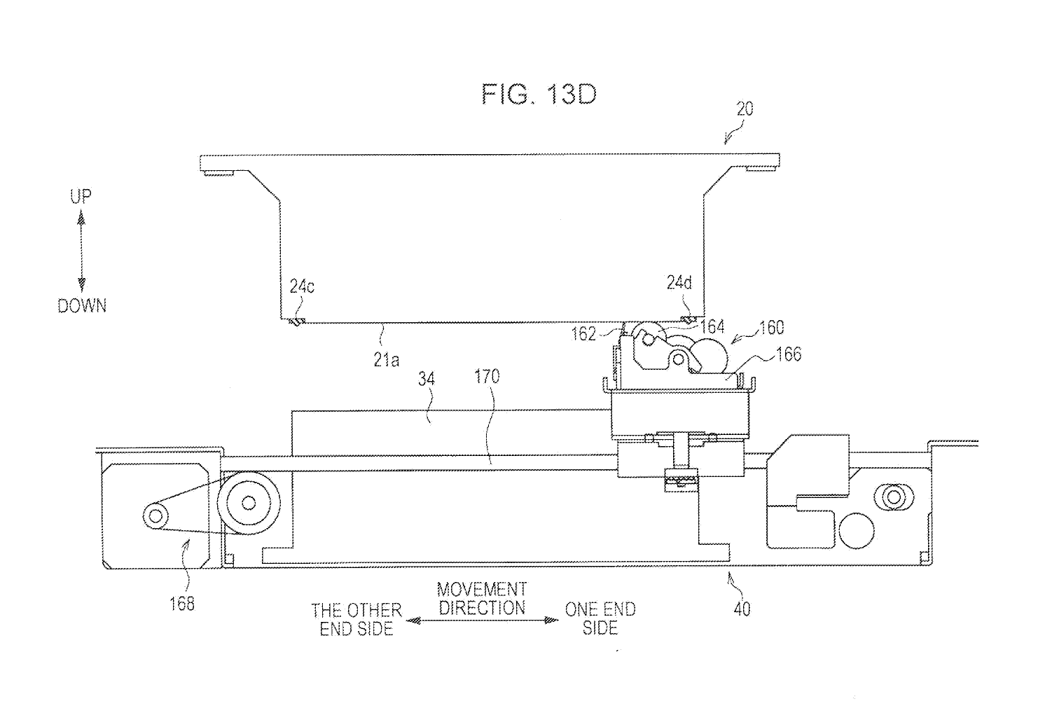

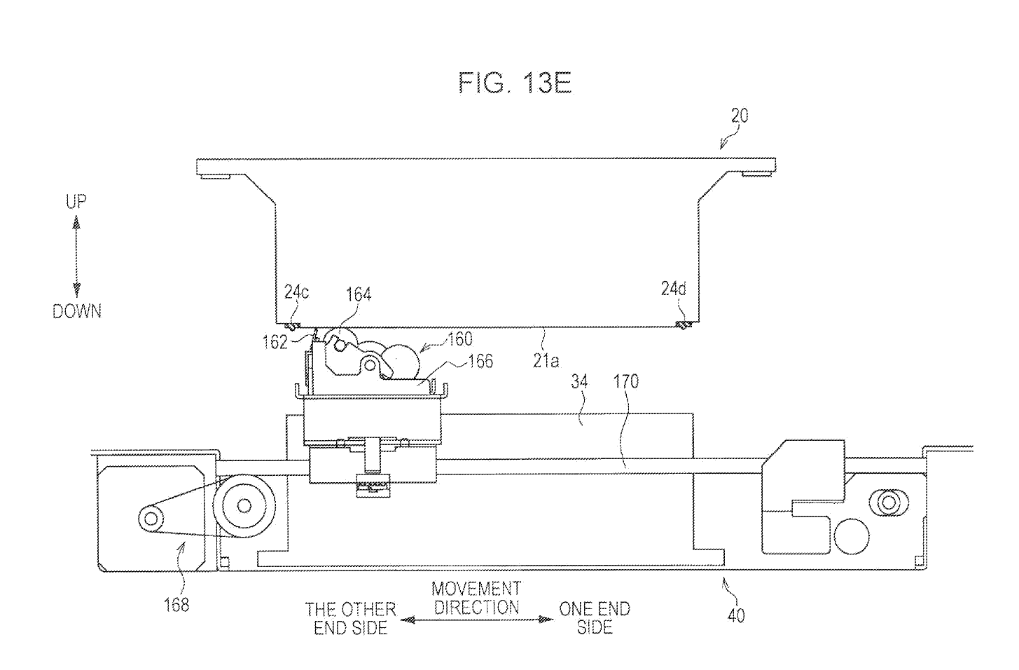

A cleaning operation of the nozzle surface 21a by the cleaning unit 160 will be described using FIGS. 13A to 13E. FIGS. 13A to 13E are drawings for describing the cleaning of the nozzle surface 21a. FIG. 13A is a diagram that shows the state in which the nozzles Nz are sealed. FIG. 13B is a diagram that shows the state in which the maintenance unit 40 descends. FIG. 13C is a diagram that shows the state in which the mover 166 is moved to the lower portion of the head unit 20. FIG. 13D is a diagram that shows the starting state of the cleaning of the nozzle surface 21a. FIG. 13E is a diagram that shows the ending state of the cleaning of the nozzle surface 21a.

The cleaning operation according to the present embodiment is, for example, performed on the nozzle surface 21a of the line head 21 after performing the suction operation by the suction pump to the line head 21. The cleaning operation is executed by the controller 70.

In the following description, the cleaning operation is started from the shown in FIG. 13A, that is, from the state in which the platen 34 abuts against the rib 23.

Firstly, from the state shown in FIG. 13A, the maintenance unit 40 descends in the vertical direction. That is, the maintenance unit 40 descends along a pair of shafts 172 (FIG. 2) due to a driving source (not shown). Moreover, the descended maintenance unit 40 is stopped in the descending position shown in FIG. 13B. As a result, a large space is formed between the platen 34 and the line head 21.

After that, in the state in which the maintenance unit 40 is situated in the descending position, the mover 166 of the cleaning unit 160 is moved to the space that is formed between the platen 34 and the line head 21. Specifically, the mover 166 is moved from one end side of the movement direction to the other side along the shaft guide 170 by the driving portion 168. Moreover, the mover 166 is stopped in the position shown in FIG. 13C.

After that, the maintenance unit 40 ascends in the vertical direction. Moreover, the ascended maintenance unit 140 is stopped in the cleaning position shown in FIG. 13D. Moreover, when the maintenance unit 40 is situated in the cleaning position, the blade 162 and the wiper 164 abut against the nozzle surface 21a of the line head 21.

In the state in which the blade 162 and the wiper 164 abut against the nozzle surface 21a, the blade 166 is moved to the position shown in FIG. 13E, whereby the nozzle surface 21a is cleaned by the blade 162 and the wiper 164. That is, the dust or the thickening ink attached to the nozzle surface 21a is scraped by the blade 162, and the dust or the thickening ink attached to the nozzle surface 21a is wiped by the wiper 164.

After the mover 166 is stopped in the position shown in FIG. 13E, the mover 166 returns to the position shown in FIG. 13B, whereby the cleaning operation is finished. After that, the maintenance unit 40 is moved to the position shown in FIG. 13A, and the platen 34 seals the nozzles Nz again.

In this manner, according to the present embodiment, when the platen 34 seals the nozzles Nz, even if the cleaning operation is executed, it is possible to greatly reduce the time when the platen 34 does not seal the nozzles Nz, and thus the states of the nozzles Nz can be suitably maintained.

### 6. Effectiveness of Printer According to the Present Embodiment

The effectiveness of the printer 10 according to the present embodiment will be described while comparing to a comparative example.

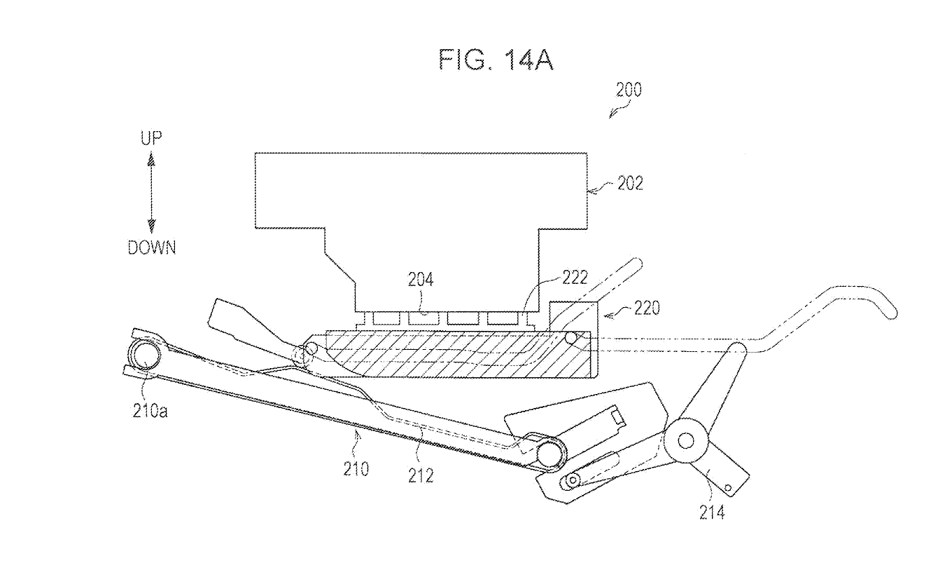

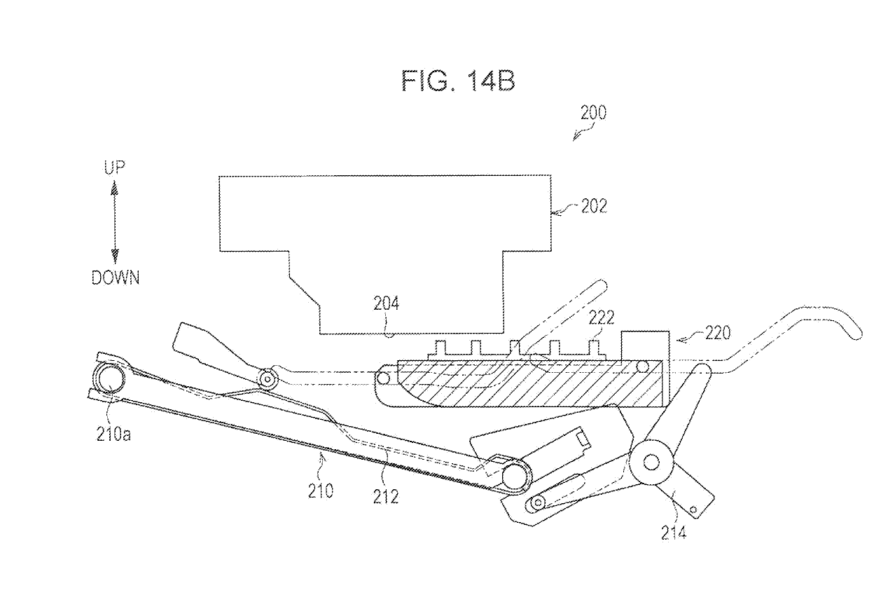

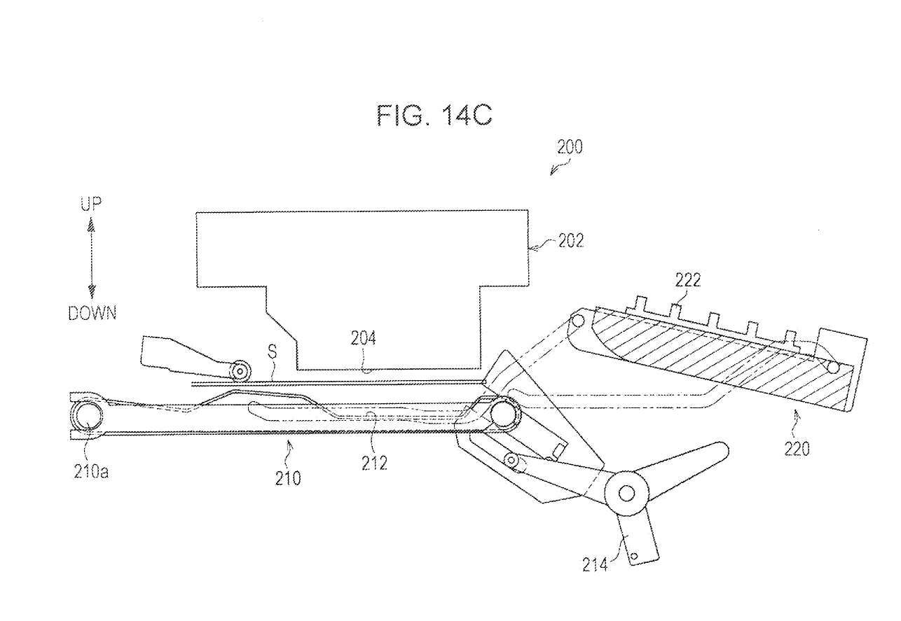

Firstly, a printer 200 according to comparative examples shown in FIG. 14A to 14C will be described. FIG. 14A is a diagram that shows a standby state in which a cap member abuts against the nozzle surface. FIG. 14B is a diagram that shows the movement state of the transport portion and the cap unit. FIG. 14C is a diagram that shows a printing state in which the cap member is retreated.

In the comparative examples, when the transition from the standby state shown in FIG. 14A to the printing state shown in FIG. 14C is performed, a transport portion 210 including a platen 212, and a cap unit 220 including a cap member 222 are moved, respectively. That is, the cap unit 220 is slidably moved, and a lever 214 is rotated in connection with the slide movement, whereby the transport portion 210 is rotated around the rotation shaft 210a. Owing to such a configuration, there is a necessity for a region where the transport portion 210 and the cap unit 220 are moved, and the apparatus becomes larger. Furthermore, a mechanism, which moves the transport portion 210 and the cap unit 220, is complicated, and the number of the components is increased. Additionally, since the movement amount of moving the cap unit 220 is increased, for example, the transition time from the printing state to the standby state is enlarged, whereby the drying of the nozzles or the like is easily generated.

Contrary to this, in the printer 10 according to the present embodiment, when the line head 21 and the platen 34 face each other, as shown in FIGS. 7 and 10, the nozzles can be sealed simply by raising the platen 34. In this manner, since the movement of the transport unit 20 or the like is not generated in the present embodiment, the configuration of the printer 10 can be simplified as compared to the comparative examples.

Furthermore, in the present embodiment, since the platen 34 is simply moved vertically, the movement amount of the platen 34 is small, and there is no necessity to increase the surrounding space. For this reason, as compared to the comparative example, the time up to the sealing of the nozzle can be shortened.

Moreover, in the present embodiment, the nozzles are sealed in the space surrounded by the platen 34 and rib 23. That is, the platen 34 has the function of sealing the nozzles Nz as well as supporting the paper S during printing. This enables the platen 34 to be further effectively utilized as compared to the comparative example in which only the cap member 222 seals the nozzles Nz.

Furthermore, in the present embodiment, until the nozzles are unsealed to discharge the ink, the movement or the like of the transport unit 20 does not occur, and thus, the sealing state of the nozzles can be continued until the paper S reaches the head unit 20. Meanwhile, in the comparative example, since the transport portion 210 is moved along with the movement of the cap unit 220, the time from after the nozzles are unsealed to when ink is discharged is lengthened, and there is concern that a disadvantage such as drying of the nozzles may occur in the meantime.

In this manner, according to the printer 10 relating to the present embodiment, the nozzles Nz can be rapidly sealed using a simple configuration, and it is possible to reduce the time from the unsealing of the nozzles to the ink discharging onto the paper S. As a consequence, the time of sealing the nozzles can be maximally secured, and thus, it is possible to further effectively protect the nozzles from the dust, the drying or the like. Similarly, even when executing the cleaning operation from the sealing state of the nozzles, the transition to the cleaning operation can be quickly performed.

### 7. Other Embodiments

As mentioned above, the preferred embodiments of the present disclosure were described in detail with reference to the drawings, but the present disclosure is not limited to the embodiments. It is evident that a person having ordinary knowledge in the field of technology to which the present disclosure belongs can contemplate various changes and modifications within scope of technical idea described in the claims, and it is understood that they also fall within the technical scope of the present disclosure.

Furthermore, in the embodiment mentioned above, although the ink jet printer as the liquid discharging apparatus was described, the present disclosure is not limited thereto. For example, the same technology as the present disclosure may be applied to various liquid discharging devices which apply an ink jet technology such as a color filter manufacturing device, a dyeing device, a micromachining device, a semiconductor manufacturing device, a surface machining device, a three-dimensional molding machine, an organic EL manufacturing device, and a display manufacturing device.

Furthermore, although, as the energy generating element, the heating resistor was described as an example in the embodiment mentioned above, the present disclosure is not limited thereto. For example, as the energy generating element, it is also possible to use a heating element other than the heating resistor (heater or the like) or a piezoelectric element such as a piezo element.

Furthermore, although, as the liquid discharging head, the line head 21 was described as an example in the embodiment mentioned above, the present disclosure is not limited thereto. For example, the present disclosure may be applied to a so-called serial type printer which discharges the ink while moving the printer head on the medium in a specific direction.

Moreover, although it was described that the protrusion 25 of the rib 23 abuts (line-contact) against the abutting surface 34a of the platen 34 in the embodiment mentioned above, the present disclosure is not limited thereto. For example, the rib 23 does not have the protrusion, but may come into surface-contact with the abutting surface 34a.

Furthermore, although it was described that the ring 23 collectively seals the plurality of color nozzles in the embodiment mentioned above, the present disclosure is not limited thereto. For example, ribs may be provided for each color of ink.

The present disclosure contains subject matter related to that disclosed in Japanese Priority Patent Application JP 2010-188556 filed in the Japan Patent Office on August 25, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid discharging apparatus comprising:
a liquid discharging head that has a nozzle surface formed with nozzles discharging liquid, and a surrounding portion that is protruded from the nozzle surface and surrounds the nozzles; and
a support member that is moved between a contact position coming into contact with the surrounding portion and a separation position separated from the surrounding portion, when being situated in the separation position, the support member supporting a medium on which liquid discharged from the nozzles is landed, and when being situated in the contact position, the support member sealing the nozzles.

2. The liquid discharging apparatus according to claim 1,
wherein the liquid discharging head has a spur which is provided to the upstream side in the transport direction of the medium further than the surrounding portion, protruded from the surrounding portion toward the support member, and is capable of coming into contact with the medium.

3. The liquid discharging apparatus according to claim 2,
wherein the spur is supported on the liquid discharging head by a spring shaft.

4. The liquid discharging apparatus according to claim 2,
wherein the support member has a concave portion that accommodates the spur when being situated in the contact position.

5. The liquid discharging apparatus according to claim 1,
wherein the surrounding portion has a protrusion portion that comes into contact with the support member when the support member is situated in the contact position, and
the support member seals the nozzles by coming into contact with the protrusion portion.

6. The liquid discharging apparatus according to claim 1,
wherein the liquid discharging head is fixedly supported so as not to be movable to an apparatus main body.

7. A liquid discharging head comprising:
a nozzle surface formed with nozzles which discharge liquid to a medium supported by opposed support members; and
a surrounding portion that is protruded from the nozzle surface and surrounds the nozzles, when coming into contact with the support members, the surrounding portion sealing the nozzles.
